(19) United States
(12) Patent Application Publication
(10) Pub. No.: US 2026/0135713 A1
(43) Pub. Date: May 14, 2026

(54) METHOD AND DEVICE FOR PERFORMING DEBUGGING AUTHENTICATION USING DIGITAL SIGNATURE

(71) Applicant: Samsung Electronics Co., Ltd., Suwon-si (KR)

(72) Inventors: Wonhee CHO, Suwon-si (KR); Mungyu BAE, Suwon-si (KR); Jisoo KIM, Suwon-si (KR); Yongjae LEE, Suwon-si (KR); Younsung CHU, Suwon-si (KR)

(73) Assignee: Samsung Electronics Co., Ltd., Suwon-si (KR)

(21) Appl. No.: 19/306,531

(22) Filed: Aug. 21, 2025

(30) Foreign Application Priority Data
Nov. 13, 2024 (KR) 10-2024-0161329

(51) Int. Cl. H04L 9/32; H04L 9/00

(52) U.S. Cl. CPC H04L 9/3247; H04L 9/008

(57) ABSTRACT

Provided are a method and device for performing debugging authentication using a digital signature. The method of performing debugging authentication using a digital signature includes sending, by a host, a debug mode entry request to a device, transmitting, by the device, a nonce to the host, generating, by the host, a digital signature corresponding to the nonce based on an encrypted digital signature private key, transmitting, by the host, the digital signature to the device, performing, by the device, a decryption operation on the digital signature based on a homomorphic encryption secret key to obtain a decrypted digital signature, performing, by the device, a verification operation on the decrypted digital signature based on a digital signature public key, and transmitting, by the device, a debug mode entry response to the host based on a result of the verification operation.

### CROSS-REFERENCE TO RELATED APPLICATION

This application is based on and claims priority under 35 U.S.C. § 119 to Korean Patent Application No. 10-2024-0161329, filed on Nov. 13, 2024, in the Korean Intellectual Property Office, the disclosure of which is incorporated by reference herein in its entirety.

### BACKGROUND

The inventive concepts relate to a method and device for performing debugging authentication using a digital signature, and more particularly, to a method of generating a digital signature using homomorphic encryption and verifying the digital signature.

When a device malfunctions, a host may put the device into debug mode to determine the cause of the malfunction. For this, an authentication procedure using a digital signature may be performed between the device and the host, and based on the result of this authentication, the host is granted access to the device operating in debug mode.

The authentication method using a digital signature has a structure in which a digital signature private key is generated first, and then a corresponding digital signature public key is generated. Due to this structure, when the digital signature private key is leaked in an authentication method using a digital signature, a security vulnerability related to debugging authentication may occur.

In special environments such as data centers, debugging may be performed on a device when the device is offline, that is, not connected to a server. Due to the environmental constraints of being offline, the digital signature private key and digital signature public key required (or used) for the authentication process through digital signature may be stored on the host as well as the server. Additionally, a plurality of devices may have a structure that performs digital signature authentication operations using the same digital signature private key and digital signature public key pair (or similar digital signature private key and digital signature public key pairs). In this case, when the digital signature private key is leaked to the outside, a challenge occurs where the host may access other devices that are not authorized to access debug mode and perform debugging operations.

Homomorphic encryption (HE) refers to an encryption method or encryption technology that allows certain operations to be performed on data even in an encrypted state. With HE, even if encrypted data is not decrypted and operations are performed on the ciphertext, the same result (or a similar result) may be obtained as performing the operation on unencrypted data and then obtaining the encrypted value.

### SUMMARY

The inventive concepts provide a method and device capable of improving the security of a digital signature private key stored in a host by encrypting the digital signature private key with a homomorphic encryption secret key. Embodiments provide for a method to protect the digital signature private key stored in the host as described above.

In addition, the inventive concepts provide a method and device capable of improving the security of a host's digital signature private key by generating the homomorphic encryption secret key based on a unique value unique to each device.

The technical challenges of the inventive concepts are not limited to the technical challenges mentioned above, and other technical challenges not mentioned are clearly understood by those skilled in the art from the description below.

According to an aspect of the inventive concepts, there is provided a method of debugging authentication, the method including sending, by a host, a debug mode entry request to a device, transmitting, by the device, a nonce to the host, generating, by the host, a digital signature corresponding to the nonce based on an encrypted digital signature private key, transmitting, by the host, the digital signature to the device, performing, by the device, a decryption operation on the digital signature based on a homomorphic encryption secret key to obtain a decrypted digital signature, performing, by the device, a verification operation on the decrypted digital signature based on a digital signature public key, and transmitting, by the device, a debug mode entry response to the host based on a result of the verification operation.

According to an aspect of the inventive concepts, there is provided a device including a memory storing a seed value and a digital signature public key, and processing circuitry configured to generate a debug mode entry response based on a debug mode entry request and a digital signature received from an external device, generate a nonce based on the debug mode entry request, transmit the nonce to the external device, perform a decryption operation on the digital signature based on a homomorphic encryption secret key to obtain a decrypted digital signature, the homomorphic encryption secret key being generated based on the seed value, and perform a verification operation on the decrypted digital signature based on the digital signature public key.

According to an aspect of the inventive concepts, there is provided a method of debugging authentication, the method including generating, by a server, an encrypted digital signature private key corresponding to a digital signature private key, transmitting, by the server, the encrypted digital signature private key to a host, transmitting, by the host, a debug mode entry request to a device, transmitting, by the device, a nonce to the host, transmitting, by the host, a digital signature to the device, the digital signature corresponding to the nonce and being based on the encrypted digital signature private key, verifying, by the device, a validity of the digital signature by performing a decryption operation and a verification operation on the digital signature, and transmitting, by the device, a debug mode entry response to the host based on a result of the verifying.

According to an aspect of the inventive concepts, there is provided a system including a host and a device, the host being configured to send a debug mode entry request to the device, generate a digital signature corresponding to a nonce based on an encrypted digital signature private key, and transmit the digital signature to the device, the device being configured to transmit the nonce to the host in response to the debug mode entry request, perform a decryption operation on the digital signature based on a homomorphic encryption secret key to obtain a decrypted digital signature, perform a verification operation on the decrypted digital signature based on a digital signature public key, and transmit a debug mode entry response to the host based on a result of the verification operation.

According to an aspect of the inventive concepts, there is provided a non-transitory computer-readable medium storing instructions that, when executed by processing circuitry of a device, cause the device to generate a nonce based on a debug mode entry request from an external device, transmit the nonce to the external device, perform a decryption operation on the digital signature based on a homomorphic encryption secret key to obtain a decrypted digital signature, the digital signature corresponding to the nonce, and the homomorphic encryption secret key being generated based on the seed value, perform a verification operation on the decrypted digital signature based on the digital signature public key, and generate a debug mode entry response based on a result of the verification operation.

### BRIEF DESCRIPTION OF THE DRAWINGS

Embodiments of the inventive concepts will be more clearly understood from the following detailed description taken in conjunction with the accompanying drawings in which:

FIG. 1 is a block diagram illustrating a system according to embodiments;

FIG. 2 is a diagram illustrating a seed value according to embodiments;

FIGS. 3A and 3B are diagrams illustrating an encrypted private key according to embodiments;

FIG. 4 is a flowchart illustrating generating an encrypted private key according to embodiments;

FIG. 5 is a diagram illustrating a device according to embodiments;

FIG. 6 is a diagram illustrating a host according to embodiments;

FIG. 7 is a flowchart illustrating an authentication operation based on a challenge-response protocol between a host and a device according to embodiments;

FIG. 8 is a flowchart illustrating a digital signature verification operation of a device according to embodiments;

FIGS. 9A and 9B are diagrams illustrating a digital signature authentication operation according to embodiments;

FIG. 10 is a block diagram illustrating an electronic device according to embodiments; and

FIG. 11 is a block diagram illustrating a solid state drive (SSD) system according to embodiments.

### DETAILED DESCRIPTION

Hereinafter, embodiments of the inventive concepts are described in detail with reference to the attached drawings. When explaining with reference to drawings, identical, similar or corresponding components are given the same drawing reference numerals (or similar drawing reference numerals) and any duplicate explanation may be omitted.

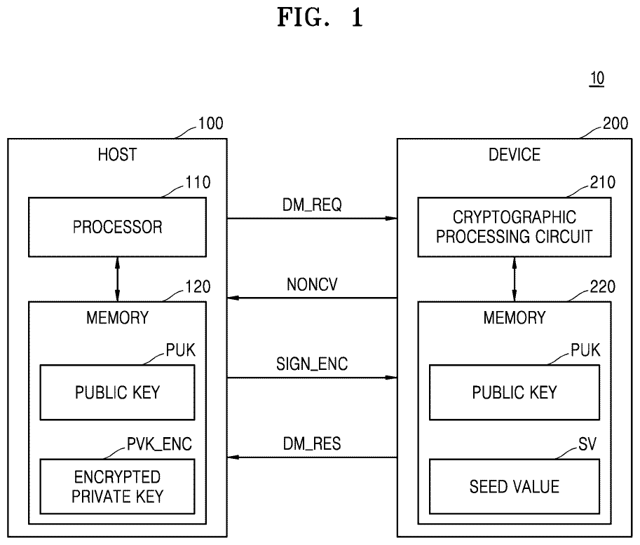

FIG. 1 is a block diagram illustrating a system 10 according to embodiments.

Referring to FIG. 1, the system 10 may include a host 100 and/or a device 200.

In embodiments, the system 10 may be implemented as an internal memory built into an electronic device, for example, an embedded universal flash storage (UFS) memory device, an embedded multi-media card (eMMC), a solid state drive (SSD), etc. In embodiments, the system 10 may be implemented as an external memory attachable to or removable from the electronic device, for example, a UFS memory card, a compact flash (CF) memory card, a secure digital (SD) memory card, a micro secure digital (Micro-SD) memory card, a mini secure digital (Mini-SD) memory card, an extreme digital (xD) memory card, a memory stick, etc.

The host 100 may include a processor 110 and memory 120. The processor 110 may be a device capable of processing data, such as a central processing unit (CPU), a neural processing unit (NPU), a graphics processing unit (GPU), or an application processor (AP). The processor 110 may execute an operating system (OS) and/or various applications.

The processor 110 and the memory 120 may communicate with each other. The memory 120 may be any hardware capable of storing information and accessible by the processor 110. The memory 120 may be configured to store keys required (or otherwise, used) for an authentication protocol using a digital signature between the host 100 and the device 200. For example, a public key PUK and an encrypted private key PVK_ENC may be stored in the memory 120. In this specification, the memory 120 may be referred to as a first memory or host memory. Additionally, the public key PUK may be referred to as a digital signature public key, the private key may be referred to as a digital signature private key, and the encrypted private key PVK_ENC may be referred to as an encrypted digital signature private key.

In embodiments, the encrypted private key PVK_ENC may be a key that encrypts a private key corresponding to the public key PUK, based on a homomorphic encryption algorithm. The key used to encrypt the private key with the encrypted private key PVK_ENC may be a homomorphic encryption secret key.

In embodiments, the memory 120 may include a read only memory (ROM), a random-access memory (RAM), a dynamic random access memory (DRAM), a double-data-rate dynamic random access memory (DDR-DRAM), a synchronous dynamic random access memory (SDRAM), a static random access memory (SRAM), a magnetoresistive random access memory (MRAM), a programmable read only memory (PROM), an erasable programmable read only memory (EPROM), an electrically erasable programmable read only memory (EEPROM), a flash memory, a polymer memory, a phase change memory, a ferroelectric memory, a silicon-oxide-nitride-oxide-silicon (SONOS) memory, a magnetic card/disk, an optical card/disk, or a combination of two or more of these.

The host 100 and the device 200 may perform authentication operations associated with the host 100 entering a debug mode of the device 200 using a challenge-response authentication method.

In embodiments, an interface used for challenge-response authentication between the host 100 and the device 200 may be joint test action group (JTAG).

The device 200 may include a cryptographic processing circuit 210 and a memory 220. The cryptographic processing circuit 210 may transmit a corresponding response to the host 100 based on signals received from the host 100. The host 100 may transmit a debug mode entry request DM_REQ and an encrypted digital signature SIGN_ENC to the device 200. The device 200 may transmit a nonce value NONCV and a debug mode entry response DM_RES to the host 100.

In cryptography, nonce is an abbreviation for “number used once” and may refer to an arbitrary (or otherwise, given) number or string of characters used only once in a security protocol. The nonce may be used to prevent replay attacks in security protocols (or reduce the likelihood thereof), and the nonce may be generated with a different value each time it is generated. In this specification, the nonce value NONCV may be a value indicating a nonce and may be used for a challenge-response authentication protocol between the host 100 and the device 200.

In embodiments, the device 200 may transmit the nonce value NONCV to the host 100 in response to the debug mode entry request DM_REQ transmitted by the host 100 through the cryptographic processing circuit 210.

In embodiments, the host 100 may generate the encrypted digital signature SIGN_ENC based on the nonce value NONCV received from the device 200 and the encrypted private key PVK_ENC and transmit the generated encrypted digital signature SIGN_ENC to the device 200. In this specification, generating the digital signature SIGN_ENC may refer to generating signed data by signing the nonce value NONCV based on the encrypted private key PVK_ENC.

In embodiments, the device 200 may verify the validity of the encrypted digital signature SIGN_ENC by performing a decryption operation and a verification operation on the encrypted digital signature SIGN_ENC received from the host 100, and determine whether to approve the host 100 to enter the debug mode for the device 200 based on the validity. When the device 200 decides (or determines) to approve the host 100 to enter the debug mode for the device 200, the device 200 may transmit the debug mode entry response DM_RES indicating the approval for entry into the debug mode to the host 100. When the device 200 decides (or determines) to reject the host 100 from entering the debug mode for the device 200, the device 200 may transmit the debug mode entry response DM_RES indicating the rejection of debug mode entry to the host 100.

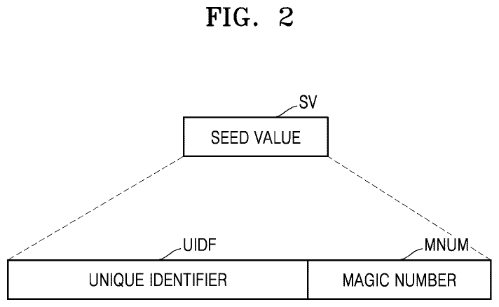

The cryptographic processing circuit 210 and the memory 220 may communicate with each other. The memory 220 may be any hardware that is capable of storing information and accessible by the cryptographic processing circuit 210. In this specification, the memory 220 may be referred to as a second memory. The public key PUK and a seed value SV may be stored in the memory 220. The seed value SV may be a unique value representing the device 200. A detailed description of the seed value SV is provided below with reference to FIG. 2.

In embodiments, the public key PUK stored in the memory 220 may match the public key PUK stored in the memory 120 of the host 100, or may be a value obtained by hashing the public key PUK stored in the memory 120 of the host 100 based on a hash algorithm.

In embodiments, the memory 220 may be an one-time programmable (OTP) memory. The OTP memory may refer to a non-volatile memory that may record data only once. Because the OTP memory is not capable of erasing or changing programmed data, the OTP memory may be used to store data during the manufacturing process or initial setup and then maintain the data thereafter.

In embodiments, the public key PUK and the seed value SV stored in the memory 220 may be values preset (or alternatively, given) during the manufacturing of the device 200 or values recorded (e.g., to the memory 220) by an external device (e.g., a server) after the manufacturing of the device 200.

According to embodiments, the private key itself corresponding to the public key PUK is not stored in the host 100, and by performing the authentication operation through the challenge-response authentication protocol between the host 100 and the device 200, the device 200 may be operated in debug mode only through an authenticated host, e.g., a host 100 with a valid digital signature. Through this, the security of the system 10 performing debugging authentication may be improved.

FIG. 2 is a diagram illustrating the seed value SV according to embodiments. In detail, FIG. 2 is a diagram illustrating the configuration of the seed value SV stored in the memory 220 of FIG. 1. FIG. 2 may be described with reference to FIG. 1, and the description already given may be omitted.

Referring to FIG. 2, the seed value SV may include a unique identifier UIDF and a magic number MNUM.

The unique identifier UIDF may be a unique value that the device 200 has. In embodiments, the unique identifier UIDF may be a serial number of the device 200. According to embodiments, for example, the unique identifier (UIDF) may be unique with respect to the identifiers (e.g., serial numbers) of other corresponding devices.

The magic number MNUM is a value set by the manufacturer of the device 200 when producing the device 200, and may be a value shared by a plurality of devices.

In embodiments, it is assumed that there are a first device and a second device having the same configuration as (or a similar configuration to) the device 200 and manufactured by the same manufacturer (or a similar manufacturer). Because the serial numbers of the first and second devices are different, their unique identifiers UIDFs may be different. Also, because the first device and the second device are manufactured by the same manufacturer (or similar manufacturers), the magic number MNUM may be the same (or similar between the first and second devices).

In embodiments, the seed value SV may be a value stored in the memory 220, when the device 200 is produced, together with the public key PUK.

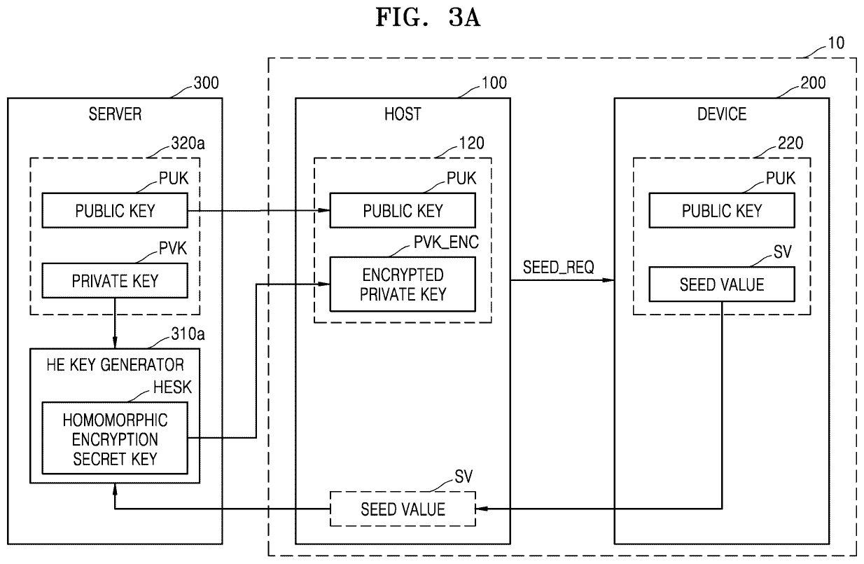

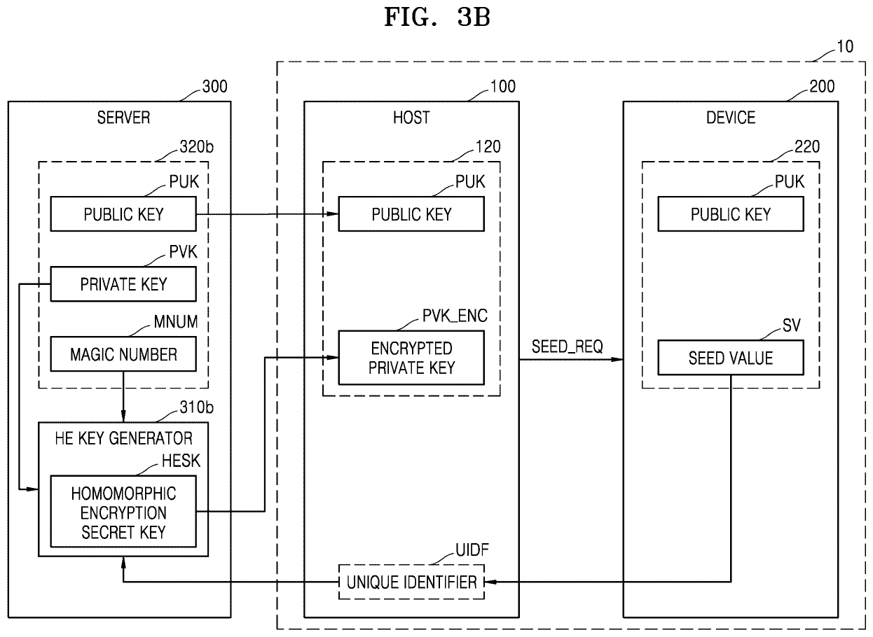

FIGS. 3A and 3B are diagrams illustrating an encrypted private key PVK_ENC according to embodiments. In detail, FIG. 3A and FIG. 3B are diagrams illustrating storing, through a server 300, the encrypted private key PVK_ENC that is obtained by encrypting a private key PVK, in the host 100 through. FIGS. 3A and 3B may be described with reference to FIGS. 1 and 2, and the description already given may be omitted.

In FIG. 3A, it is assumed that the private key PVK and the public key PUK for an asymmetric key encryption method (or a public key encryption method) are stored in a memory 320a of the server 300. The public key PUK may be a value generated based on the private key PVK.

Referring to FIG. 3A, the server 300 may include a homomorphic encryption (HE) key generator 310a and a memory 320a. The memory 320a may include a ROM, a RAM, a DRAM, a DDR-DRAM, an SDRAM, a SRAM, an MRAM, a PROM, an EPROM, an EEPROM, a flash memory, a polymer memory, a phase change memory, a ferroelectric memory, a SONOS memory, a magnetic card/disk, an optical card/disk, or a combination of two or more of these. In this specification, the memory 320a may be referred to as a third memory.

In embodiments, the server 300 may be a hardware security module (HSM).

In embodiments, the server 300 may be the HSM operated by the manufacturer of the device 200.

To encrypt the private key PVK, the server 300 may request the seed value SV from the device 200 through the host 100. The host 100 may transmit a seed value request SEED_REQ to the device 200. The device 200 may transmit the seed value SV to the host 100 in response to a seed value request SEED_REQ. The host 100 may transmit the seed value SV received from the device 200 to the server 300.

In embodiments, the seed value SV may include a unique identifier (FIG. 2, UIDF) and a magic number (FIG. 2, MNUM).

The HE key generator 310a of the server 300 may generate a homomorphic encryption secret key HESK based on the seed value SV received from the host 100. The HE key generator 310a may generate the encrypted private key PVK_ENC by encrypting the private key PVK using the generated homomorphic encryption secret key HESK. The HE key generator 310a may transmit the encrypted private key PVK_ENC to the host 100. That is, rather than storing the private key PVK itself in the host 100, the encrypted private key PVK_ENC may be stored.

In embodiments, the device 200 may generate the homomorphic encryption secret key HESK based on the seed value SV. The homomorphic encryption secret key HESK generated by the device 200 may be the same as (or similar to) the homomorphic encryption secret key HESK generated by the HE key generator 310a of the server 300. The homomorphic encryption key HESK may be used to both encrypt and decrypt data. For example, when data is encrypted with the homomorphic encryption key HESK, the encrypted data may be decrypted using the homomorphic encryption key HESK.

In FIG. 3B, it is assumed that the private key PVK, the public key PUK, and the magic number MNUM are stored in the memory 320b of the server 300. According to embodiments, the implementation of the memory 320b may be the same as or similar to the implementation of the memory 320a.

Referring to FIG. 3B, to encrypt the private key PVK, the server 300 may request the seed value SV from the device 200 through the host 100. The host 100 may transmit the seed value request SEED_REQ to the device 200. The device 200 may transmit the seed value SV to the host 100 in response to the seed value request SEED_REQ. In this case, instead of transmitting the entire seed value SV, the device 200 may transmit the unique identifier UIDF corresponding to a portion of the seed value SV to the host 100 as the seed value SV. The host 100 may transmit the unique identifier UIDF received from the device 200 to the server 300.

In embodiments, the server 300 may be the HSM operated by the manufacturer of the device 200. Accordingly, the server 300 may have the magic number (MNUM, FIG. 2) corresponding to the device 200 stored in advance, and accordingly, the server 300 may not need (or receive) the magic number MNUM when receiving the seed value SV.

An HE key generator 310b of the server 300 may generate the seed value SV based on the magic number MNUM and the unique identifier UIDF received from the host 100. The HE key generator 310b may generate the homomorphic encryption secret key HESK based on the generated seed value SV (including both the unique identifier UIDF and the magic number MNUM). The HE key generator 310b may generate the encrypted private key PVK_ENC by encrypting a private key PVK using the generated homomorphic encryption secret key HESK. The HE key generator 310b may transmit the encrypted private key PVK_ENC to the host 100.

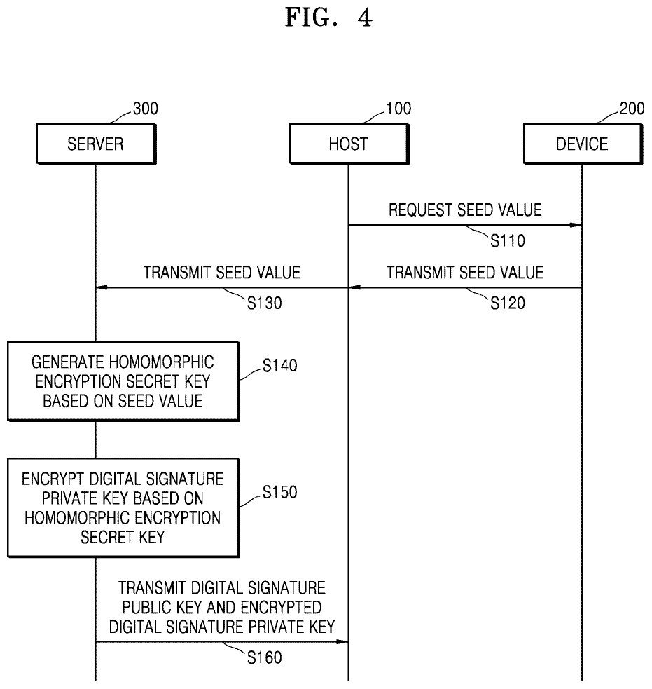

FIG. 4 is a flowchart illustrating generating the encrypted private key PVK_ENC according to embodiments. FIG. 4 may be described with reference to FIGS. 1 to 3B, and the description already given may be omitted.

Referring to FIG. 4, in operation S110, the host 100 may send a seed value request SEED_REQ to the device 200.

In embodiments, the seed value request SEED_REQ may be transmitted by the host 100 to the device 200 based on a request from the server 300 to the host 100.

In operation S120, the device 200 may transmit the seed value SV to the host 100 based on the seed value request SEED_REQ received from the host 100.

In embodiments, the seed value SV transmitted by the device 200 to the host 100 may include a unique identifier (FIG. 2, UIDF) and a magic number (FIG. 2, MNUM).

In embodiments, the seed value SV that the device 200 transmits to the host 100 may not include the magic number MNUM but may include only the unique identifier UIDF.

In operation S130, the host 100 may transmit the seed value SV received from the device 200 to the server 300.

In operation S140, the server 300 may generate the homomorphic encryption secret key HESK based on the seed value SV received from the host 100.

In operation S150, the server 300 may generate the encrypted private key PVK_ENC by encrypting the private key PVK based on the homomorphic encryption secret key HESK.

In embodiments, the private key PVK and the public key PUK may be a key pair using an asymmetric key encryption method. In this case, because the homomorphic encryption secret key HESK is a key generated based on a unique value of the device 200, the private key PVK encrypted based on the homomorphic encryption secret key HESK may differ depending on the seed value SV of the device.

In operation S160, the server 300 may transmit the public key PUK and the encrypted private key PVK_ENC to the host 100. The host 100 may store the public key PUK and the encrypted private key PVK_ENC received from the server 300 in the memory 120.

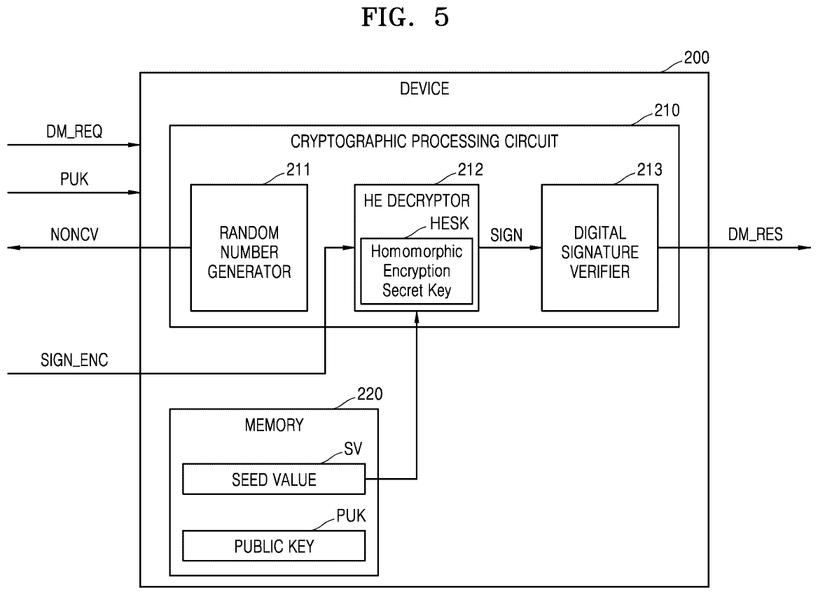

FIG. 5 is a diagram illustrating the device 200 according to embodiments. FIG. 5 may be described with reference to FIGS. 1 to 4, and the description already given may be omitted.

Referring to FIG. 5, the device 200 may include the cryptographic processing circuit 210 and the memory 220.

The cryptographic processing circuit 210 may include a random number generator 211, an HE decryptor 212, and/or a digital signature verifier 213. In embodiments, the cryptographic processing circuit 210 may be referred to as an encryption IP.

The device 200 may receive the debug mode entry request DM_REQ from the host 100. In this case, the public key PUK may also be received along with the debug mode entry request DM_REQ.

In embodiments, the public key PUK may be included in the debug mode entry request DM_REQ.

The cryptographic processing circuit 210 may compare the public key PUK received from the host 100 with the public key PUK stored in the memory 220 of the device 200. The cryptographic processing circuit 210 may generate the nonce value NONCV through the random number generator 211 and transmit the generated nonce value NONCV to the host 100 when (e.g., in response to determining that) the public key PUK received from the host 100 matches the public key PUK stored in the memory 220 of the device 200.

In embodiments, instead of the public key PUK, a hash value of the public key PUK may be stored in the memory 220. In this case, the encryption processing circuit may compare the public key PUK received from the host 100 with the hash value of the public key PUK stored in the memory 220 of the device 200. The cryptographic processing circuit 210 may generate the nonce value NONCV through the random number generator 211 and transmit the generated nonce value NONCV to the host 100 when the public key PUK received from the host 100 matches (or corresponds to) the hash value of the public key PUK stored in the memory 220 of the device 200.

The random number generator 211 may generate the nonce value NONCV. The nonce value NONCV may be a random value (or a pseudo-random value) that is different each time.

In embodiments, the random number generator 211 may be referred to as a digital true random number generator (DTRNG).

The HE decryptor 212 may generate a homomorphic encryption secret key HESK based on the seed value SV stored in the memory 220. The HE decryptor 212 may decrypt the encrypted digital signature SIGN_ENC received from the host 100 based on the generated homomorphic encryption secret key HESK, and output a digital signature SIGN as a result of decrypting the encrypted digital signature SIGN_ENC.

In embodiments, the encrypted digital signature SIGN_ENC may be data generated by the host 100 performing a homomorphic cryptographic operation on the nonce value NONCV and the encrypted private key PVK_ENC based on a homomorphic encryption secret key HESK.

Then digital signature verifier 213 may receive a digital signature SIGN from the HE decryptor 212 and verify the validity of the digital signature SIGN. In detail, the digital signature verifier 213 may perform a validation operation on the digital signature SIGN based on the public key PUK stored in memory 220 or the public key PUK received from the host 100, and generate the debug mode entry response DM_RES based on the verification result.

In embodiments, the digital signature algorithm used by the digital signature verifier 213 may be elliptic curve digital signature algorithm (ECDSA). These are examples for illustrative purposes only and are not intended to limit the inventive concepts.

In embodiments, when the digital signature verifier 213 determines that the digital signature SIGN is valid as a result of performing a validation operation on the digital signature SIGN, the digital signature verifier 213 may generate an approval response as the debug mode entry response DM_RES and transmit the generated approval response to the host 100. According to embodiments, the device 200 may change its operation mode to the debug mode in response to determining the digital signature SIGN is valid. According to embodiments, the host 100 and/or the device 200 may program and/or read a memory (e.g., the memory 220) in the debug mode. For example, the device 200 may apply a program voltage (e.g., according to a command form the host 100) to one or more transistors in the memory to program the one or more transistors to maintain specific program voltages. According to embodiments, the host 100 and/or the device 200 may detect (e.g., read) one or more settings or parameters of the device 200 in the debug mode, and/or change (e.g., update) one or more settings or parameters of the device 200 in the debug mode (e.g., to correct a malfunction of the device 200).

In embodiments, when the digital signature SIGN is determined to be invalid as a result of performing a validation operation on the digital signature SIGN, the digital signature verifier 213 may generate a rejection response as the debug mode entry response DM_RES and transmit the generated rejection response to the host 100.

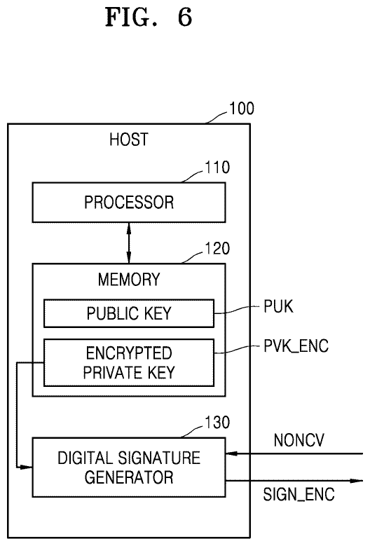

FIG. 6 is a diagram illustrating the host 100 according to embodiments. FIG. 6 may be described with reference to FIGS. 1 to 5, and the description already given may be omitted.

Referring to FIG. 6, the host 100 may include the processor 110, the memory 120, and/or a digital signature generator 130. The digital signature generator 130 may be implemented in various forms and provided to the host 100. For example, the digital signature generator 130 may be implemented as hardware (HW), such as a control circuit, for performing various processes related to digital signatures. Alternatively, the digital signature generator 130 may be implemented as software including a program, in which case the processor 110 may perform various processes related to the digital signature by executing the digital signature generator 130 loaded into the memory 120. Alternatively, the digital signature generator 130 may be implemented as a combination of HW and SW.

The digital signature generator 130 may generate a digital signature in response to the nonce value NONCV received from the device 200. In detail, the digital signature generator 130 may generate the encrypted digital signature SIGN_ENC by encrypting the nonce value NONCV based on the encrypted private key PVK_ENC. In this case, the digital signature generator 130 may generate the encrypted digital signature SIGN_ENC by performing a homomorphic cryptographic operation using the encrypted private key PVK_ENC and the nonce value NONCV.

In embodiments, the digital signature algorithm used by the digital signature generator 130 may be elliptic curve digital signature algorithm (ECDSA). These are examples for illustrative purposes only and are not intended to limit the inventive concepts.

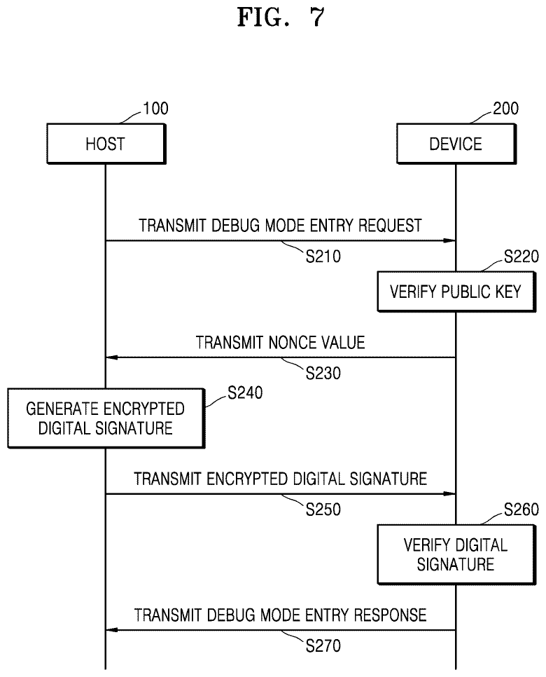

FIG. 7 is a flowchart illustrating an authentication operation based on a challenge-response protocol between the host 100 and the device 200 according to embodiments. FIG. 7 may be described with reference to FIGS. 1 to 6, and the description already given may be omitted.

Referring to FIG. 7, in operation S210, the host 100 may transmit the debug mode entry request DM_REQ and the public key PUK to the device 200.

In embodiments, the debug mode entry request DM_REQ may include the public key PUK.

In operation S220, the device 200 may perform a verification operation on the public key PUK received from the host 100.

In embodiments, the device 200 may verify the public key PUK received from the host 100 by comparing the public key PUK stored in the memory 220 with the public key PUK received from the host 100. When the public key PUK stored in the memory 220 matches the public key PUK received from the host 100, the device 200 may determine that the public key PUK received from the host 100 is valid.

In embodiments, a hashed value of the public key PUK may be stored in the memory 220 of the device 200. In this case, the device 200 may verify the public key PUK received from the host 100 by comparing the hashed value of the public key PUK with the public key PUK received from the host 100. When the hash value of the public key PUK stored in the memory 220 matches the public key PUK received from the host 100, the device 200 may determine that the public key PUK received from the host 100 is valid.

In operation S230, when the device 200 determines (e.g., in response to determining) that the public key PUK received from the host 100 is valid as a result of performing a verification operation on the public key PUK received from the host 100 in operation S220, the device 200 may generate a nonce value NONCV and transmit the generated nonce value NONCV to the host 100.

In operation S240, the host 100 may generate the encrypted digital signature SIGN_ENC based on the nonce value NONCV received from the device 200 and an encrypted private key PVK_ENC.

In embodiments, the host 100 may generate the encrypted digital signature SIGN_ENC by performing a homomorphic cryptographic operation based on the nonce value NONCV received from the device 200.

In embodiments, the host 100 may generate the encrypted digital signature SIGN_ENC by performing the homomorphic encryption operation based on a hash value corresponding to the nonce value NONCV received from the device 200 and the encrypted private key PVK_ENC. A hash algorithm may be used for the host 100 to generate a hash value corresponding to the nonce value NONCV. The hash algorithm used to generate the hash value may be adopted from among various types of hash algorithms such as, for example, message digest algorithm 5 (MD5), secure hash algorithm (SHA)-1, SHA-2, SHA-3, and blake2, but this is an example and is not intended to limit the inventive concepts.

In operation S250, the host 100 may transmit the encrypted digital signature SIGN_ENC to the device 200.

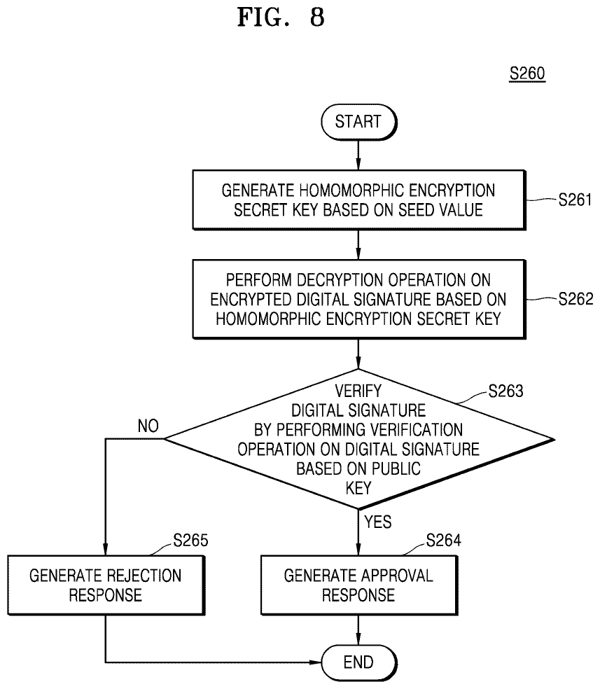

In operation S260, the device 200 may verify the encrypted digital signature SIGN_ENC received from the host 100. In detail, the device 200 may verify the encrypted digital signature SIGN_ENC through a decryption operation and a verification operation. A specific description of operation S260 is provided below with reference to FIG. 8.

In operation S270, the device 200 may transmit the debug mode entry response DM_RES to the host 100 based on a result of the verification in operation S260.

In embodiments, based on the result of the verification in operation S260, when the encrypted digital signature SIGN_ENC received from the host 100 is determined to be valid (e.g., in response to this determination), the approval response may be transmitted to the host 100 as the debug mode entry response DM_RES. In this case, the device 200 may operate in debug mode, and the host 100 that receives the approval response may access the device 200 to perform debugging.

In embodiments, based on the result of the verification in operation S260, when the encrypted digital signature SIGN_ENC received from the host 100 is determined to be invalid (e.g., in response to this determination), the rejection response may be transmitted to the host 100 as the debug mode entry response DM_RES. In this case, the device 200 may not operate in debug mode, and the host 100 that has received the rejection response may not be able to perform debugging on the device 200.

In embodiments, the operations of operations S210 to S270 illustrated in FIG. 7 may be performed in a state where the host 100 and the device 200 are not connected to the server 300, e.g., in an offline state.

FIG. 8 is a flowchart illustrating a digital signature verification operation of the device 200, according to embodiments. In detail, the flowchart illustrated in FIG. 8 may be a flowchart illustrating operation S260 of FIG. 7 in detail. FIG. 8 may be described with reference to FIGS. 1 to 7, and the description already given may be omitted.

Referring to FIG. 8, in operation S261, the device 200 may generate the homomorphic encryption secret key HESK based on the seed value SV.

In operation S262, the device 200 may perform a decryption operation on the encrypted digital signature SIGN_ENC received from the host 100 based on the homomorphic encryption secret key HESK. The decryption operation may be to generate the digital signature SIGN by decrypting then the encrypted digital signature SIGN_ENC based on the homomorphic encryption secret key HESK.

In operation S263, the device 200 may verify the validity of a digital signature SIGN based on a public key PUK. In this specification, an operation of verifying, performed by the device 200, the validity of the digital signature SIGN based on the public key PUK may be referred to as a verification operation.

In operation S264, as a result of the verification in operation S263, when the digital signature SIGN is determined to be valid, the device 200 may generate an approval response as the debug mode entry response DM_RES.

In operation S265, when as the result of the verification in operation S263 it is determined that the digital signature SIGN is invalid, the device 200 may generate the rejection response as the debug mode entry response DM_RES.

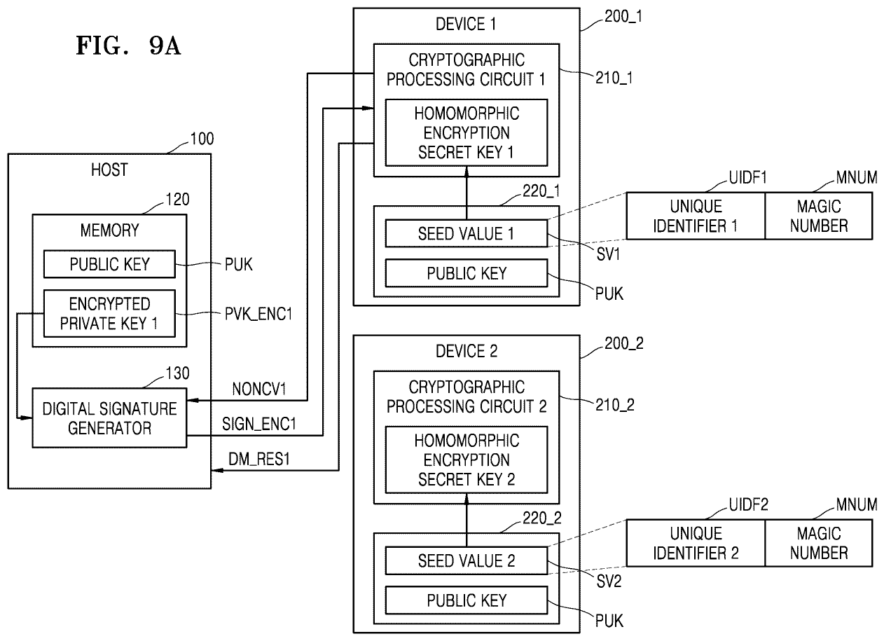

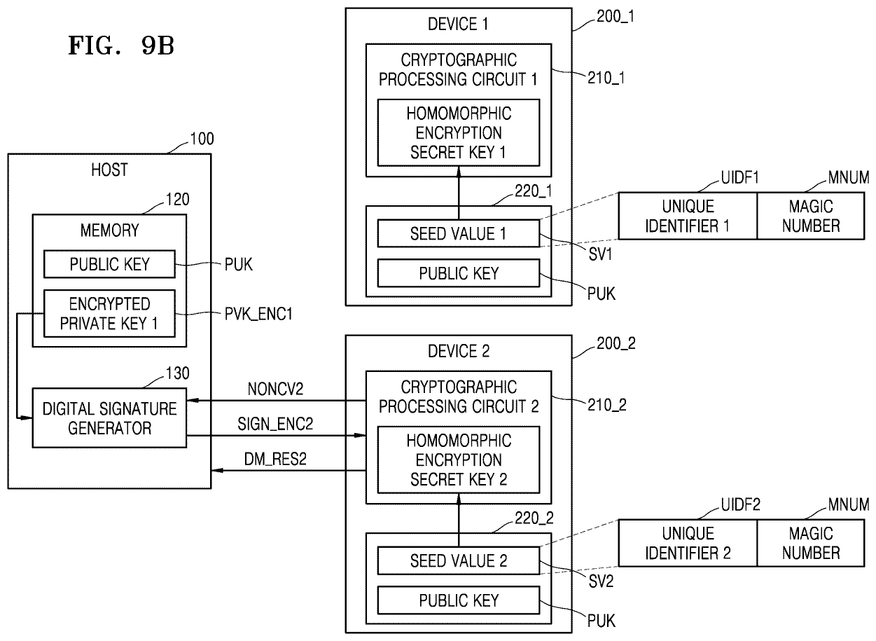

FIGS. 9A and 9B are diagrams illustrating a digital signature authentication operation according to embodiments. FIGS. 9A and 9B may be described with reference to FIGS. 1 to 8, and the description already given may be omitted.

Referring to FIGS. 9A and 9B, the host 100 may correspond to the host 100 of FIG. 1. A first device 200_1 and a second device 200_2 may each have the same configuration as (or a similar configuration to) the device 200 of FIG. 1. In this case, in FIGS. 9A and 9B, it is assumed that the public key PUK is shared by the first device 200_1, the second device 200_2, and the host 100, and it is assumed that the host 100 stores the public key PUK and a first encrypted private key PVK_ENC1 corresponding to the first device 200_1 in the memory 120. The first encrypted private key PVK_ENC1 may be a key that has previously encrypted the private key (or a key obtained based on a previous encryption of the private key) (FIG. 3A, PVK) with a first homomorphic encryption secret key HESK1 via the server (FIG. 3A, 300). In this case, the first homomorphic encryption secret key HESK1 may be a key generated from a first seed value SV1 of the first device 200_1. This may mean that the host 100 has previously obtained only debug mode access rights to the first device 200_1 through the server 300, and has not obtained debug mode access rights to the second device 200_2.

The first device 200_1 may store the public key PUK and the first seed value SV1 in a memory 220_1. The first seed value SV1 may be a value composed of a first unique identifier UIDF1 corresponding to the first device 200_1 and the magic number MNUM.

The second device 200_2 may store the public key PUK and a second seed value SV2 in the memory 220_2. The second seed value SV2 may be a value composed of a second unique identifier UIDF2 corresponding to the second device 200_2 and the magic number MNUM.

Referring to FIG. 9A, it is assumed that the host 100 transmits the debug mode entry request DM_REQ to the first device 200_1. The host 100 may perform a homomorphic encryption operation based on a first nonce value NONCV1 received from the first device 200_1 and the first encrypted private key PVK_ENC1 stored in the memory 120, thereby generating a first encrypted digital signature SIGN_ENC1, and transmit the generated first encrypted digital signature SIGN_ENC1 to the first device 200_1. The first device 200_1 may generate the first homomorphic encryption secret key HESK1 based on the first seed value SV1 through a cryptographic processing circuit 210_1, and perform a decryption operation and a verification operation for the first encrypted digital signature SIGN_ENC1 based on the first homomorphic encryption secret key HESK1. The first encrypted digital signature SIGN_ENC1 may be verified as valid through a decryption operation based on the first homomorphic encryption secret key HESK1 and a verification operation based on the public key PUK. The first device 200_1 may, in response to the first encrypted digital signature SIGN_ENC1 received from the host 100 being valid, transmit a first debug mode entry response DM_RES1 indicating approval for entry into the debug mode to the host 100.

Referring to FIG. 9B, it is assumed that the host 100 transmits the debug mode entry request DM_REQ to the second device 200_2. The host 100 may perform the homomorphic encryption operation based on a second nonce value NONCV2 received from the second device 200_2 and the first encrypted private key PVK_ENC1 stored in the memory 120, thereby generating a second encrypted digital signature SIGN_ENC2, and transmit the second encrypted digital signature SIGN_ENC2 to the second device 200_2. The second device 200_2 may generate a second homomorphic encryption secret key HESK2 based on the second seed value SV2 through a cryptographic processing circuit 210_2, and perform a decryption operation and a verification operation for the second encrypted digital signature SIGN_ENC2 based on the second homomorphic encryption secret key HESK2. In this case, because the private key used by the host 100 in the process of generating the second encrypted digital signature SIGN_ENC2 is the first encrypted private key PVK_ENC1 encrypted by the first homomorphic encryption secret key HESK1, when a decryption operation is performed on the second encrypted digital signature SIGN_ENC2 based on the second homomorphic encryption secret key HESK2, the digital signature may not be decrypted correctly, and the digital signature may be an invalid digital signature. Because digital signature data generated by the decryption operation is invalid, the result generated by performing the verification operation on the digital signature data may also be invalid. The device 200 may transmit a second debug mode entry response DM_RES2 to the host 100 indicating a refusal to enter debug mode in response to the second encrypted digital signature SIGN_ENC2 received from the host 100 being invalid.

As seen through FIGS. 9A and 9B, because the host 100 may perform debugging only for devices for which it has acquired debug mode access rights in advance, the security of each of the first and second devices 200_1 and 200_2 may be improved.

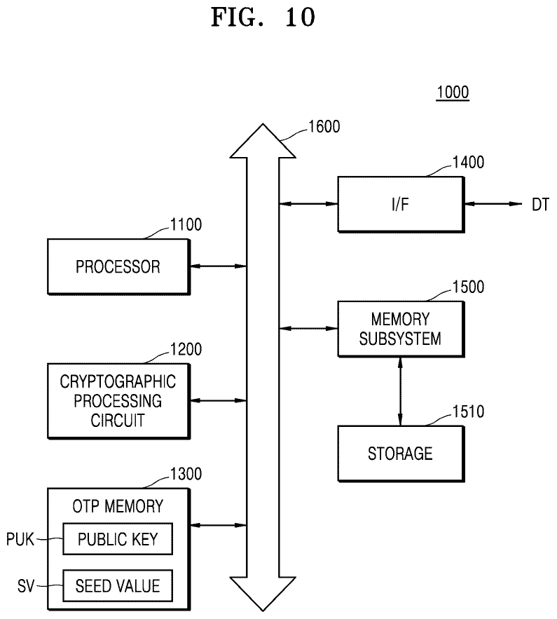

FIG. 10 is a block diagram illustrating an electronic device 1000 according to embodiments.

Referring to FIG. 10, the electronic device 1000 may include a processor 1100, an encryption processing circuit 1200 (also referred to herein as a cryptographic processing circuit 1200), an OTP memory 1300, an interface 1400, a memory subsystem 1500, a storage 1510, and/or a bus 1600. The electronic device 1000 of FIG. 10 may correspond to the device 200 of FIG. 1. Components included in the electronic device 1000 may communicate via the bus 1600.

The electronic device 1000 may be implemented as various electronic devices or included in various electronic devices. For example, the electronic device 1000 may include robotic devices such as drones, advanced driver-assistance systems (ADAS), smart televisions (TVs), smart phones, medical devices, mobile devices, video display devices, measuring devices, and Internet of things (IOT) devices, etc.

In embodiments, the electronic device 1000 may be a system-on-chip (SoC) in which components are implemented on a single chip, and the storage 1510 may be external to the system-on-chip. In embodiments, at least one of the components illustrated in FIG. 10 may be omitted from the electronic device 1000.

The processor 1100 may control the operation of the electronic device 1000 at the highest layer and control other components of the electronic device 1000. The processor 1100 may communicate with the memory subsystem 1500 and execute instructions. In embodiments, the processor 1100 may execute a program stored in the memory subsystem 1500. The program may include a series of instructions. The processor 1100 may be any hardware capable of independently executing instructions, and may be referred to as an application processor (AP), a communication processor (CP), a central processing unit (CPU), a processor core, a core, etc.

The encryption processing circuit 1200 may transmit a nonce value in response to data DT received from outside the electronic device 1000 or perform a verification operation on the data DT received from outside.

The OTP memory 1300 may store the public key PUK and the seed value SV. The public key PUK may be used to perform verification operations on digital signatures received from external sources. The seed value SV may include a unique value (e.g., a serial number) of the electronic device 1000.

The electronic device 1000 may have improved security when performing authentication operations through an external device and a digital signature through the encryption processing circuit 1200 and the OTP memory 1300.

The interface 1400 may receive input from the outside of the electronic device 1000 (e.g., the host 100 of FIG. 1) and transmit an interface for transmitting output to the outside of the electronic device 1000. In embodiments, the electronic device 1000 may transmit and receive the data DT with the outside. For example, the electronic device 1000 may transmit and receive the data DT to and from a smart card, memory card, or other device.

The memory subsystem 1500 may be accessed by other components connected to the bus 1600. In embodiments, the memory subsystem 1500 may include volatile memory such as DRAM or SRAM, or may include non-volatile memory such as flash memory or resistive random access memory (RRAM). In addition, in embodiments, the memory subsystem 1500 may transmit an interface to the storage 1510. The storage 1510 may be a non-transitory storage medium that does not lose data even when power is cut off. For example, the storage 1510 may include a semiconductor memory device such as a non-volatile memory, or may include any storage medium such as a magnetic card/disk or an optical card/disk. A task analysis method according to embodiments may be stored in the memory subsystem 1500 or the storage 1510.

The memory subsystem 1500 may be accessed by the processor 1100 and may store software elements executable by the processor 1100. A software element may include, but is not limited to, a software component, a program, an application, a computer program, an application program, a system program, a software development program, a machine program, an operating system (OS) software, middleware, firmware, a software module, a routine, a subroutine, a function, a method, a procedure, a software interface, an application program interface (API), an instruction set, computing code, computer code, a code segment, a computer code segment, a word, a value, a symbol, or a combination of two or more of these.

The bus 1600 may operate based on one of several bus protocols. The various bus protocols may include at least one of advanced microcontroller bus architecture (AMBA) protocol, universal serial bus (USB) protocol, multimedia card (MMC) protocol, peripheral component interconnection (PCI) protocol, PCI-express (PCI-E) protocol, advanced technology attachment (ATA) protocol, serial-ATA protocol, parallel-ATA protocol, small computer small interface (SCSI) protocol, enhanced small disk interface (ESDI) protocol, integrated drive electronics (IDE) protocol, mobile industry processor interface (MIPI) protocol, universal flash storage (UFS) protocol, etc.

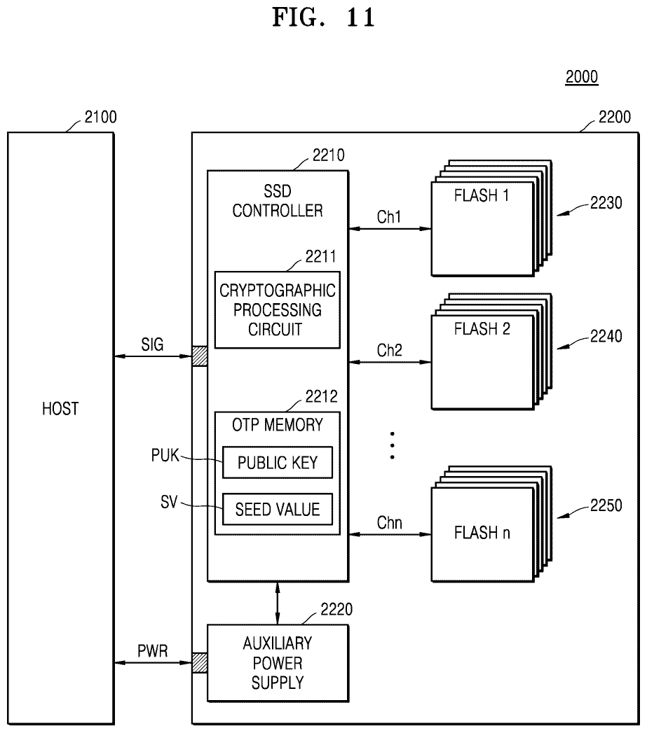

FIG. 11 is a block diagram illustrating an SSD system 2000 according to embodiments.

The SSD system 2000 may include a host 2100 and an SSD 2200. The SSD 2200 may exchange signals with the host 2100 through a signal connector and may receive power through a power connector. The SSD 2200 may include an SSD controller 2210, an auxiliary power supply 2220, and/or a plurality of flash memory devices 2230, 2240, and/or 2250. The SSD controller 2210 may communicate with a plurality of flash memory devices through a first channel Ch1 to an nth channel Chn (n is an integer greater than or equal to 1).

The SSD controller 2210 may include an encryption processing circuit 2211 and an OTP memory 2212. The encryption processing circuit 2211 and the OTP memory 2212 may be implemented using the examples illustrated in FIGS. 1 to 10.

The SSD system 2000 may have improved security related to authentication operation through digital signature between the host 2100 and the SSD 2200 through the encryption processing circuit 2211 and the OTP memory 2212.

In order to operate an SSD device in a debugging mode, the host and SSD device operate offline. To enter the debugging mode, the SSD device authenticates a digital signature of the host using public key encryption. In order to facilitate the offline authentication of the digital signature, conventional devices and methods involve storing a private key of the SSD device in a memory of the host. However, this storage of the private key on the host represents a vulnerability that enables unauthorized access to the SSD device in the debugging mode in the event the private key is leaked from the memory of the host. Accordingly, the conventional devices and methods for debugging authentication provide insufficient security.

However, according to embodiments, improved devices and methods are provided for debugging authentication. For example, the improved devices and methods encrypt a private key of an SSD device (e.g., using a homomorphic encryption secret key generated based on a unique value of the SSD device) and store the encrypted private key in the memory of a host (e.g., without storing the private key of the SSD device in the memory of the host). As such, the host is able to generate a digital signature using the encrypted private key and provide the digital signature to the SSD device offline for debugging authentication, and the SSD device is able to decrypt the digital signature based on the unique value of the SSD device and validate the decrypted digital signature. Accordingly, the improved devices and methods overcome the deficiencies of the conventional devices and methods to at least improve security of debugging authentication.

According to embodiments, operations described herein as being performed by the system 10, the host 100, the device 200, the processor 110, the cryptographic processing circuit 210, the server 300, the HE key generator 310a, the HE key generator 310b, the random number generator 211, the HE decryptor 212, the digital signature verifier 213, the digital signature generator 130, the first device 200_1, the second device 200_2, the cryptographic processing circuit 210_1, the cryptographic processing circuit 210_2, the electronic device 1000, the processor 1100, the encryption processing circuit 1200, the interface 1400, the memory subsystem 1500, the SSD system 2000, the host 2100, the SSD 2200, the SSD controller 2210, the auxiliary power supply 2220, each among the plurality of flash memory devices 2230, 2240, and/or 2250, and/or the encryption processing circuit 2211 may be performed by processing circuitry. The term ‘processing circuitry,’ as used in the present disclosure, may refer to, for example, hardware including logic circuits; a hardware/software combination such as a processor executing software; or a combination thereof. For example, the processing circuitry more specifically may include, but is not limited to, a central processing unit (CPU), an arithmetic logic unit (ALU), a graphics processing unit (GPU), a digital signal processor, a microcomputer, a field programmable gate array (FPGA), a System-on-Chip (SoC), a programmable logic unit, a microprocessor, application-specific integrated circuit (ASIC), etc.

The various operations of methods described above may be performed by any suitable device capable of performing the operations, such as the processing circuitry discussed above. For example, as discussed above, the operations of methods described above may be performed by various hardware and/or software implemented in some form of hardware (e.g., processor, ASIC, etc.).

The software may comprise an ordered listing of executable instructions for implementing logical functions, and may be embodied in any “processor-readable medium” for use by or in connection with an instruction execution system, apparatus, or device, such as a single or multiple-core processor or processor-containing system.

The blocks or operations of a method or algorithm, and/or functions, described in connection with embodiments disclosed herein may be embodied directly in hardware, in a software module executed by a processor, or in a combination of the two. If implemented in software, the functions may be stored on or transmitted over as one or more instructions or code on a tangible, non-transitory computer-readable medium. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art.

While the inventive concepts have been particularly shown and described with reference to embodiments thereof, it will be understood that various changes in form and details may be made therein without departing from the spirit and scope of the following claims.

What is claimed is:

1. A method of debugging authentication, the method comprising:
sending, by a host, a debug mode entry request to a device;
transmitting, by the device, a nonce to the host;
generating, by the host, a digital signature corresponding to the nonce based on an encrypted digital signature private key;
transmitting, by the host, the digital signature to the device;
performing, by the device, a decryption operation on the digital signature based on a homomorphic encryption secret key to obtain a decrypted digital signature;
performing, by the device, a verification operation on the decrypted digital signature based on a digital signature public key; and
transmitting, by the device, a debug mode entry response to the host based on a result of the verification operation.

2. The method of claim 1, wherein
the debug mode entry request includes the digital signature public key; and
the transmitting of the nonce to the host by the device includes:
comparing the digital signature public key included in the debug mode entry request with a hash value corresponding to the digital signature public key, the hash value being stored in the device, and
transmitting, by the device, the nonce to the host in response to determining the hash value corresponds to the digital signature public key.

3. The method of claim 1, wherein the generating of the digital signature includes:
generating, by the host, a hash value corresponding to the nonce; and
generating, by the host, the digital signature based on the hash value and the encrypted digital signature private key.

4. The method of claim 1, wherein the generating of the digital signature includes generating the digital signature by performing a homomorphic cryptographic operation based on the nonce and the encrypted digital signature private key.

5. The method of claim 1, wherein the homomorphic encryption secret key is a value generated based on a seed value corresponding to the device.

6. The method of claim 5, wherein the seed value includes a serial number of the device and a magic number.

7. The method of claim 5, wherein the performing of the decryption operation includes:
generating the homomorphic encryption secret key based on the seed value; and
decrypting the digital signature based on the homomorphic encryption secret key in response to the generating of the homomorphic encryption secret key.

8. The method of claim 1,
wherein the performing of the verification operation includes verifying a validity of the decrypted digital signature by performing the verification operation; and
the transmitting of the debug mode entry response includes one of:
transmitting, by the device, an approval response as the debug mode entry response in response to determining the decrypted digital signature is valid based on the verification operation, and changing an operation mode of the device to a debug mode, or
transmitting, by the device, a rejection response as the debug mode entry response in response to determining the decrypted digital signature is invalid based on the verification operation.

9. A device comprising:
a memory storing a seed value and a digital signature public key; and
processing circuitry configured to,
generate a debug mode entry response based on a debug mode entry request and a digital signature received from an external device,
generate a nonce based on the debug mode entry request,
transmit the nonce to the external device,
perform a decryption operation on the digital signature based on a homomorphic encryption secret key to obtain a decrypted digital signature, the digital signature corresponding to the nonce, and the homomorphic encryption secret key being generated based on the seed value, and
perform a verification operation on the decrypted digital signature based on the digital signature public key.

10. The device of claim 9, wherein the memory includes one time programmable (OTP) memory.

11. The device of claim 9, wherein the debug mode entry request includes the digital signature public key.

12. The device of claim 9, wherein the seed value includes a serial number of the device and a magic number.

13. The device of claim 9, wherein the processing circuitry is configured to:
transmit an approval response as the debug mode entry response in response to determining the decrypted digital signature is valid, and change an operating mode of the device to a debug mode; and
transmits a rejection response as the debug mode entry response in response to determining the decrypted digital signature is invalid.

14. A method of debugging authentication, the method comprising:
generating, by a server, an encrypted digital signature private key corresponding to a digital signature private key;
transmitting, by the server, the encrypted digital signature private key to a host;
transmitting, by the host, a debug mode entry request to a device;
transmitting, by the device, a nonce to the host;
transmitting, by the host, a digital signature to the device, the digital signature corresponding to the nonce and being based on the encrypted digital signature private key;
verifying, by the device, a validity of the digital signature by performing a decryption operation and a verification operation on the digital signature; and
transmitting, by the device, a debug mode entry response to the host based on a result of the verifying.

15. The method of claim 14, wherein the generating of the encrypted digital signature private key includes:
requesting, by the host, the device for a seed value corresponding to the device;
transmitting, by the device, the seed value to the server through the host;
generating, by the server, a homomorphic encryption secret key based on the seed value; and
generating, by the server, the encrypted digital signature private key by encrypting the digital signature private key based on the homomorphic encryption secret key.

16. The method of claim 15, wherein the seed value includes a serial number of the device and a magic number.

17. The method of claim 14, further comprising:
transmitting, by the server, a digital signature public key to the host,
wherein
the debug mode entry request includes the digital signature public key, and
the transmitting of the nonce to the host includes,
comparing the digital signature public key included in the debug mode entry request with a hash value corresponding to the digital signature public key, the hash value being stored in the device, and
transmitting the nonce to the host in response to determining the hash value corresponds to the digital signature public key.

18. The method of claim 14, wherein the generating of the digital signature includes:
generating, by the host, a hash value corresponding to the nonce; and
generating, by the host, the digital signature based on the hash value and the encrypted digital signature private key.

19. The method of claim 14, wherein the generating of the digital signature includes generating the digital signature by performing a homomorphic cryptographic operation based on the nonce and the encrypted digital signature private key.

20. The method of claim 14, wherein the verifying of the validity of the digital signature includes:
generating, by the device, a homomorphic encryption secret key based on a seed value stored in a memory of the device;
performing, by the device, the decryption operation on the digital signature based on the homomorphic encryption secret key to obtain a decrypted digital signature; and
verifying, by the device, the decrypted digital signature by performing the verification operation based on a digital signature public key.
